(19) United States
(12) Patent Application Publication
(10) Pub. No.: US 2007/0259325 A1
(43) Pub. Date: Nov. 8, 2007

(54) INTERNET-BASED METHOD AND SYSTEM FOR HUMAN-HUMAN QUESTION AND ANSWER SESSIONS IN DELAYED AND REAL TIME

(76) Inventor: Rock L. Clapper, Palo Alto, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/739,009

(22) Filed: Apr. 23, 2007

Related U.S. Application Data
(60) Provisional application No. 60/793,965, filed on Apr. 22, 2006.

(51) Int. Cl. G09B 3/00

(52) U.S. Cl. 434/350

(57) ABSTRACT

Technology and a process allow one human to ask any question and have another human who is pre-qualified as an authority on the topic to respond directly via a wired or wireless connection over the Internet immediately or in a delayed manner. Third parties may be involved to provide rewards or incentives to promote the question and answer process.

### CROSS-REFERENCE TO RELATED APPLICATIONS

The present application relates to and claims priority of copending U.S. Provisional Patent Application (“Copending Application”), entitled “Human to Human Internet-based Method and System for Question and Answer Sessions in Delayed and Real Time,” Ser. No. 60/793,965, filed Apr. 22, 2006. The Copending Application is hereby incorporated by reference in its entirety.

### BACKGROUND OF THE INVENTION

1. Field of the Invention

The present invention relates generally to a system and a method for conducting online question and answer sessions involving two or more humans, either on a delayed basis or in real time.

2. Discussion of the Related Art

In the early days of the Internet, information made available for retrieval includes a series of databases that warehoused names of events, products and locations. Finding information on events, products, and locations was accomplished at the time by searching within a directory linked to a database. In recent years, information is located through search engines which compiled information in their own database and linked inquiries to websites containing the desired information.

Various algorithms have been used to search and to create a hierarchical list of results that are presented from processing a search query. Several searchable database technologies have provided algorithms to allow individuals to ask questions framed in a prescribed syntex. These algorithms analyze the words and the word sequences in the question, and assign weights to the type of question being asked. The technology then proceeds to locate the best fitting response, or answer, to the question, as analyzed.

One specific form of search arose when consumers began to express an interest in finding each other. The simplest process in this form of search allows people to populate a searchable database with their personal or professional data, and allow others to search the information based on categories or parameters. Examples include popular ‘online personals databases’. Advanced systems for online personals use elaborate matching algorithms that examine the dimensions of personal, professional, hobby and other characteristics. Other applications include matching car buyers with research, prices and specific vehicles from dealer inventories.

At the same time, several forms of immediate and delayed electronic communication (e.g., electronic mail or “email”) have arisen to satisfy the need for direct and indirect communications. ‘Email’ allows one online user to send a letter to another user without requiring the recipient user to be online at the time the email is sent. The email can be reviewed immediately or at a later time and is thus viewed as a passive mode of electronic communication. Another form of electronic communication is the electronic bulletin board, which allows one user to ‘post’ information “publicly” (i.e., allow viewing by any and all users of the bulletin board) and for others to respond over time. Posting to an electronic bulletin board is seen as a passive mode of electronic communication. Another form is the ‘chat’ technology that allows users to exchange text messages in real time with each other. Since ‘chatting’ can be conducted in real time or the outgoing messages can be stored until the intended recipients retrieve them, ‘chat’ is considered to be both an active mode and a passive mode of electronic communication. For example, in a ‘chat’ technology for cellular telephones, one user can send a ‘text message’ to another user. Such a message can be responded to immediately or at the leisure of the recipient. Text messaging is thus considered to be a mode of communication that is both active and passive.

‘Chat’ technology has been incorporated into customer support use, typically in the technology industries (e.g., hardware or software). Typically, a company provides online customer support in the form of a real time ‘chat’ session between the user and the company's support personnel, in lieu of the telephone voice conversation typical of customer support services of the past. This form of customer support has realized significant cost savings to companies because the cost of a ‘chat’ session is less than a telephone call, and because one online customer support agent using ‘chat’ can serve multiple customers simultaneously.

### SUMMARY OF THE INVENTION

The present invention provides a technology and a process for allowing one human to ask any question and have another human who is pre-qualified as an authority on the topic to respond directly via a wired or wireless connection (e.g., telephone or facsimile), or over the Internet, immediately or in a delayed manner. According to one embodiment of the present invention, two types of users may interact with the system: (a) the inquirers, who ask questions, and (b) the responders, who answer questions.

The present invention imposes no limit to the type of questions that can be asked. Questions can also be posed in any supported format and language. Responses to the questions may be short or elaborate statements, referrals, references, or even requests for clarification. The questions may be posed in email, chat, a text message, a posting on an electronic bulletin board, a facsimile transmission, another supported form of electronic messaging, a telephone call or a voice message. Similarly, the response to the question may be provided in email, chat, a text message, another posting on the electronic bulletin board, a facsimile transmission, another supported form of electronic messaging and, in some instances, a telephone call or voice message.

According to one embodiment of the present invention, a system uses a computer algorithm 1. to analyze the question asked by the Inquirer, and 2. to identify the best responder to answer the question. In addition, third party corporations may participate in the system by providing products and services to inquirers and responders either directly or by offering incentives to use or purchase the products and services (e.g., various forms of coupons). The system analyzes questions and responses on behalf of third party corporations and provides a system for offering incentives.

The present invention is better understood upon consideration of the detailed description below in conjunction with the accompanying drawings.

### BRIEF DESCRIPTION OF THE DRAWINGS

FIG. 1 depicts, by way of example, an overall schematic and work flow for an online auction for a nonprofit organization, in accordance with one embodiment of the present invention.

### DETAILED DESCRIPTION OF THE PREFERRED EMBODIMENTS

The present invention provides technology and a process for an Internet-based question and answer session which allows a human to ask a question that is directly input into a computer system and which allows another human who is prescreened as an authority on the topic to respond to the question. The present invention serves individuals seeking answers to any type of question or corporations, government entities, and other institutions seeking to gather personal or other information from one or more responders. In this process, the responder may respond directly to the inquirer over a wired or wireless connection to the Internet, immediately or on a delayed basis. In this detailed description below, selected terms are used consistent with the illustrative meanings provided in the following table:

| Term | Meaning |
|---|---|
| Inquirer | An individual or an entity that asks a question |
| | through the system |
| Respondent | An individual or an entity that answers a question |
| | through the system |
| The System | A computer running programs that analyze |
| | information and that enables communication |
| | between an inquirer and a respondent. |
| Algorithm | A methodical process, such as a process |
| | implemented in a computer, that executes a finite |
| | set of well-defined instructions to accomplish a |
| | given task; given an initial state, the algorithm |
| | will terminate in a corresponding, recognizable |
| | end state. |
| Third Party | An number of private or public companies who |
| Corporation | provide products, services, or represent entities |
| | who provide products or services. |
| Rewards & Incentives | Any number of products and services that are |
| | given away freely or at a discount in order to |
| | encourage a set of desirable behavior. Rewards |
| | and incentives may include, for example, |
| | membership points that may be used towards to |
| | pay for or to reduce the prices of products and |
| | services. |
| Electronic or | Any device that transmits information via the |
| Telephonic Device | Internet or over wired or wireless communication |
| | channels. |

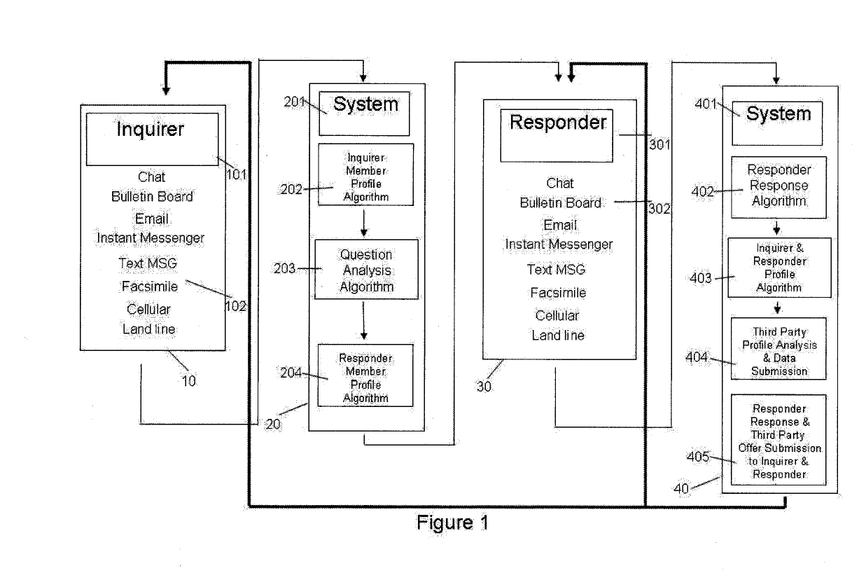

FIG. 1 illustrates schematically a work flow in a human-to-human question and answer system. As shown in FIG. 1, inquirer 101, who is a registered user (“member”), begins a session 10 using a web-enabled electronic, telephonic, or another wired or wireless device 102. A session becomes active when an initial communication in the form of an inquiry is received into computer system 20, which includes processor 201. Within computer system 20, the inquiry is analyzed initially according to algorithm 202 which examines such features as the type of communication (e.g., electronic or telephonic) and previously stored information regarding inquirer 101. Algorithm 202 determines both the allowable questions that inquirer 101 may pose to the system, and a suitable device or channel to communicate the response. These results of exercising algorithm 202 may be added to the inquirer's response profile 403 in computer system 40, which may reside on the physical computer system as computer system 20. Question analysis algorithm 203 in computer system 20 classifies the question according to such criteria as category, industry, hobby, or religion. If additional information is required of inquirer 101, computer system 20 will prompt inquirer 101 for more details or to rephrase the question in a different manner.

According to one embodiment of the present invention, an inquirer may ask as many questions as is allowed by the system, which dictates the specific number of allowed questions according to certain characteristics of the inquirer. For example, one closed system determines the number of allowed questions according to the length of time the inquirer has been as a member of the system, or the number of times the inquirer has participated as a responder. Alternatively, a fee can be assessed for each question answered, The number of allowed questions may also be determined by interactions with a third party to the system (e.g., a corporation interested in survey responses, viewing advertisements, or making purchases of products or services).

Question analysis algorithm 203 uses machine learning categorization techniques. Applicable techniques include (a) Naïve Bayesian algorithms and (b) Logistic Regression algorithms. A refinement of the Naïve Bayesian approach may include, for example, utilizing Laplace smoothing. Similarly, a refinement of the Logistic Regression approach may include, for example, utilizing L₂ regularization. The features for the categorizers can be based on a bag-of-words approach, or may use bigrams. Features that have low frequency counts can be ignored.

In one implementation of computer system 20, two categorizers or classifiers are provided. The first categorizer is implemented in question analysis algorithms 203 to map a question to a set of topic categories. For example, more than one topic may be assigned to each question, with each assigned question topic associate with a probability associated with it. The second categorizer is implemented in responder profile algorithms 204 to score a responder, as discussed further later in this detailed description. In either categorizer, the categories may be created manually, or automatically (e.g., using automated clustering techniques such as Latent Dirichlet Allocation (LDA)), or a combination of both manual and automated techniques. Each categorizer may be trained using data collected by the system, or from other related data sources. The training can be performed prior to or during the system use.

The features for the categorizers can come directly from the questions, from an interview, or from related data. Related data can include, for example, the context in which the question was being asked (e.g., a web page related to the question, or historical behavior data, including prior questions and responses, and associated metrics, of the inquirer or other users).

Once computer system 20 has determined the nature and details of the question, computer system 20 analyzes a responder profile database (according to responder profile algorithms 204) to identify one or more responders for the question asked according to a scoring scheme. The responder score consists of a set of topic categories and a set of responder profile metrics. More than one topic may be assigned to each responder, for example, with each assigned responder topic associated with a probability. The responder may be profiled by completing one or more interviews, and each interview may be category-specific. The interviews may also evaluate general responder traits, such as personality and effectiveness. The interview questions may be guided by a Naïve Bayesian algorithm to minimize the number of questions. Given the results of responder profile algorithms 204, computer system 20 contacts responder 301 via an electronic or telephonic message on platform 302 selected by the best fit responder.

A responder may provide personal, professional, hobby, interests and other lifestyle information to allow the categorizer to match the responder more effectively and efficiently to inquiries. The greater depth a responder interacts with the system in providing his or her capabilities, the more incentives may be provided to the responder.

An alternative embodiment has a single algorithm that maps a question directly to a set of preferred Responders. In anther embodiment, the system detects whether or not the question has previously been answered and archived in the database. In the case that a previous answer is found in the database, the system may respond instantly without involving a responder.

If the inquirer and the identified responder agree, they may converse directly outside of the system. To protect the identity of both parties, the system screens for direct contact attempts and eliminates these attempts until both parties are in agreement. This agreement is facilitated by the system, and may require the inquirer to pay a membership fee and may require a responder to return incentives already earned from the system.

Responders may be rewarded for responding to inquiries that may come to them in the various formats. Incentives may include, for example, points and miles to be used for purchases and travels, rank increases in a hierarchy of ‘experts’, allocation of more questions that the responder may, in turn, ask of other responders, and gifts in the form of products and services from corporations. Timely responses may be rewarded with more incentives than non-timely responses. Responses may be complicated and may involve an iterative process of successive exchanges between the inquirer and the responder. For complicated responses or processes, responders may be rewarded by greater incentives. Occasionally, multiple electronic or telephonic platforms may be required to carry out an inquiry and response session.

Using computer system 40, responder 301 provides the response in a format desired by inquirer 101 and suitable for related analyses and follow-up. Computer system 40 includes processor 401 which analyzes both the response format and using response algorithms 402. The results of the analysis may add according to process 403 to the responder's profile in the responder profile database. According to question answered, computer system 40 then identifies at process 404 one or more third party authorized to provide rewards to inquirer 101 or responder 301 in their products or services. The identified third parties are then notified. Rewards are then sent to inquirer 101 and logged into inquirer 101's profile. Similarly, the identified third parties's rewards are also submitted to responder 301.

As discussed above, the present invention may conduct question and answer sessions via electronic and telephonic transmission. Within the description of the system and method herein for conducting question and answer sessions, successful inquiries can be developed in individual or multi-part sessions.

I claim:

1. A system, comprising:
an interface for receiving a question electronically or telephonically from an individual or an entity inquirer;
a processor in a computer system which analyzes the received question to identify one or more responders for the question according to the question and profiles of responders in a responder database;
an interface to a communication channel for contacting one of the identified responders regarding the received question;
an interface for receiving a response from the contacted responder; and
a processor in the computer system for processing the received response.

2. A system as in claim 1, wherein the response is provided electronically or telephonically.

3. A system as in claim 1, wherein the computer system includes a classifier for classifying the received question into one or more predetermined topics.

4. A system as in claim 1, wherein the computer system includes a classifier for classifying the received question into one or more automatically generated topics.

5. A system as in claim 4, wherein the automatically generated topics are created based on one or more of: data analysis programs, communication from experts and the questions posed to the system.

6. A system as in claim 1, the computer system further comprising a database for storing previously posed questions and previously provided responses, wherein when the computer system recognizes the question as a previously posed question archived in the database, the computer system retrieves and returns to the inquirer the corresponding previously provided response.

7. A system as in claim 1, wherein the computer system identifies responders based on one or more of the following characteristics: profession, demographic data, hobby information, and personal preferences.

8. A system as in claim 1, further comprising a processor that identifies one or more third parties interested in communicating with either the responder or the inquirer.

9. A system as in claim 8, wherein the third parties provide incentives to the inquirer or responder to patronize their products or services.

10. A method, comprising:
receiving a question electronically or telephonically from an individual or an entity inquirer;
analyzing the received question to identify one or more responders for the question according to the question and profiles of responders in a responder database;
contacting one of the identified responders regarding the received question; and
receiving and processing a response from the contacted responder.

11. A method as in claim 10, wherein the response is provided electronically or telephonically.

12. A method as in claim 10, wherein analyzing the received question includes classifying the received question into one or more predetermined topics.

13. A method as in claim 10, wherein analyzing the received question includes classifying the received question into one or more automatically generated topics.

14. A method as in claim 13, wherein the automatically generated topics are created based on one or more of: data analysis programs, communication from experts and the questions posed to the system.

15. A method as in claim 10, further comprising:
providing a database for storing previously posed questions and previously provided responses;
determining whether or not the question as a previously posed question archived in the database;
upon determining that the question was previously posed and previously provided, retrieving and returning the corresponding previously provided response to the inquirer.

16. A method as in claim 10, wherein identifying responders including scoring the responders based on one or more of the following characteristics: profession, demographic data, hobby information, and personal preferences.

17. A method as in claim 10, further comprising identifying, based on the results of analyzing the received question, one or more third parties interested in communicating with either the responder or the inquirer.

18. A method as in claim 16, wherein the third parties provide incentives to the inquirer or responder to patronize their products or services.
